(19) United States
(12) Patent Application Publication
(10) Pub. No.: US 2008/0114624 A1
(43) Pub. Date: May 15, 2008

(54) CLICK-FRAUD PROTECTOR

(75) Inventor: Brendan James Kitts, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/559,291

(22) Filed: Nov. 13, 2006

(51) Int. Cl. G06Q 30/00

(52) U.S. Cl. 705/7

(57) ABSTRACT

Determining the probability that a user or program fraudulently initiated a web-page request is described herein. A data-mining component is configured to determine attributes associated with the web-page request. A computation component is configured to calculate a probability that the web-page request was fraudulently initiated. To calculate this probability, the attributes and other parameters are fed into a statistical model. An auction component is configured to locate one or more advertisements to display on the web page based on the probability. The auction component may also be configured to restrict the advertisements for display based on advertiser-specified target criteria.

### BACKGROUND

The World Wide Web has become a popular medium for advertisers. Highly-trafficked web sites can charge advertisers significant rates to display online advertisements, such as banner ads, pop-ups, interstitial ads, floating ads, etc. Online advertisements are typically displayed on a requested web page, with the results of a search-engine query, or within e-mails. The cost to advertise online is usually proportionate to the volume of traffic visiting a particular web page or requesting a specific web search.

Various methods are currently used to sell online advertisements. A web publisher or advertising network may charge an advertiser a fee per each impression of an advertisement displayed. Pay-per-click advertising is an alternative arrangement where an advertiser pays a publisher or advertising network a charge-per-click rate every time an online advertisement is selected by a user. In either situation, advertisers typically want to ensure that their advertisements are either viewed or clicked by interested users.

One problem with pay-per-click advertising is click fraud. In general, click fraud occurs when a person or computer program imitates a legitimate user by clicking on an online advertisement for the purpose of generating an improper charge per click. Two different types of click fraud currently exist. First, publishing click fraud (sometimes referred to as syndication click fraud) occurs when a user or program selects an advertisement to generate revenue for a hosting publisher or advertising network. Every time an advertisement is selected, the publisher or advertising network hosting the web page is entitled to a royalty. Thus, the publisher or advertising network may constantly click the advertisements to generate income. Additionally, a search engine may be used to call the advertisement, implicating the search engine in click fraud. As a result, the search engine may be liable for numerous click fraud violations for just displaying advertisements.

Competitive click fraud is another type of click fraud in which a user or program tries to deplete the budget of another advertiser by constantly selecting an advertisement. For instance, advertisers' may repeatedly click on a competitor's advertisement. Consequently, the competitor must pay for each competitor click.

Click-fraud methods have become rather sophisticated. Not only can click fraud be perpetrated by a user repeatedly clicking an advertisement, but various automated methods can also be used. Spyware and other malicious software can be downloaded onto an unassuming user's computer and configured to constantly click advertisements. As a result, numerous computers can be used as proxies to perform click fraud. The downloaded software may automatically click advertisements in the background of a computing device without a user even knowing.

Traditional methods for addressing click fraud simply monitor click streams and identify fraudulent clicks using various algorithms. Once a fraudulent click is identified, the advertiser is refunded the per-click rate. Typically, publishers or search engines handle such algorithms to identify click fraud. But this poses another problem. The search engine or publisher receives a rate for each advertisement click and is in charge of determining what clicks are fraudulent and qualify for a refund. Thus, it is in the best interest of the search engine or publisher to have fewer fraudulent clicks. Unfortunately, the advertiser is left with no control over displaying advertisements to possibly-fraudulent web traffic. The advertiser is forced to rely on the good faith of the publisher or search engine.

Another problem stemming from online advertising is impression fraud. Online advertisements may be sold by the impression. Impressions refer to an advertisement's appearance on an accessed web page. For example, three web advertisements displayed on a web page would constitute three impressions. Publishers or advertising networks can charge advertisers for each advertisement impression they present on a given web page. Impression fraud may be induced by constantly requesting a web page, thus requiring advertisers to pay every time their impressions are presented.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Determining the probability that a user or program fraudulently initiated a web-page request is described herein. A web service executing on a server includes a data-mining component, computation component, and auction component. The data-mining component is configured to determine attributes associated with the web-page request. The computation component is configured to calculate a probability that the web-page request was fraudulently initiated. To calculate this probability, the attributes and other parameters are fed into a statistical model. The auction component is configured to locate one or more advertisements to display on the web page based on the probability. The auction component is also configured to restrict the advertisements for display based on advertiser-specified target criteria. Once an advertisement is located, the advertisement is rendered along with the web page.

### BRIEF DESCRIPTION OF THE SEVERAL VIEWS OF THE DRAWINGS

The present invention is described in detail below with reference to the attached drawing figures, wherein:

FIG. 1 is a block diagram of a computing-system environment for use in implementing an embodiment of the present invention;

FIG. 2 is a block diagram of an exemplary system for determining the probability that a user or program will commit click fraud and displaying an advertisement on a web page, according to an embodiment of the present invention;

FIG. 3 is a flowchart illustrating a process for determining the probability that a user or program will commit click fraud and displaying an advertisement on a web page, according to an embodiment of the present invention;

FIG. 4 is a flowchart illustrating a process for an advertiser to specify target criteria, according to an embodiment of the present invention;

FIG. 5 is a graphical user interface for an advertiser to specify target criteria, according to an embodiment of the present invention;

FIG. 6 is a graphical user interface for an advertiser to specify target criteria, according to an embodiment of the present invention;

FIG. 7 is a graphical user interface for an advertiser to specify target criteria, according to an embodiment of the present invention; and

FIG. 8 illustrates a graphical user interface of a keyword list specified by an advertiser, according to an embodiment of the present invention.

### DETAILED DESCRIPTION

The subject matter described herein is presented with specificity to meet statutory requirements. The description herein, however, is not intended to limit the scope of this patent. Rather, it is contemplated that the claimed subject matter might also be embodied in other ways, to include different steps or combinations of steps similar to the ones described in this document, in conjunction with other present or future technologies. Moreover, although the term “block” may be used herein to connote different elements of methods employed, the term should not be interpreted as implying any particular order among or between various steps herein disclosed.

Embodiments described herein generally relate to reducing the influence of click fraud and allowing advertisers to control the display of their online advertisements. It should be noted that an advertiser may be any user who wishes to buy space on a web page to place an advertisement.

Some embodiments presented herein are directed to one or more computer-readable media configured to determine the probability that a user or program fraudulently initiated a web-page request. The terms fraudulent or fraudulently, as used herein, are used to connote selecting or inducing the display of an online advertisement for the purpose of click fraud or impression fraud. In addition, a web page request may be deemed fraudulent if there is a probability that the request is originating from an automated system e.g., a program that constantly clicks advertisements. The terms fraudulent or fraudulently may also be used as a measure of the probability that a web-page request is deemed invalid. Furthermore, whether or not a web-page request is fraudulent may also refer to the probability that the request the presentation of an advertisement to a user will result in the user selecting the advertisement.

In an embodiment, a web service executing on a server includes a data-mining component, computation component, and auction component are used. The data-mining component may be configured to determine attributes from the web-page request. The computation component may be configured to calculate a probability that the web-page request was fraudulently initiated. To calculate this probability, the attributes and other target criteria are fed into a statistical model. The auction component may be configured to locate one or more advertisements to display on the web page based on the probability. The auction component may also be configured to restrict the advertisements for display based on advertiser-specified target criteria. Once an advertisement is located, the advertisement can be rendered along with the web page.

It should be noted that a web-page request may also include a search-engine query. The former is discussed extensively herein; however, embodiments also contemplate the latter. For example, a web-page request may include both a request for www.msn.com and searching for “shoes” on the MSN® search engine. Therefore, the embodiments discussed herein may be applied to both a request for a web page and a search-engine query.

In addition, some embodiments discussed herein are directed to a graphical user interface enabling an advertiser to supply target criteria. In one embodiment, web-page criteria may be displayed on the user interface. The advertiser can designate web-page criteria as target criteria. Once specified, the target criteria can then be transmitted to a server and used by the auction component to determine whether to present an advertisement on a requested web page.

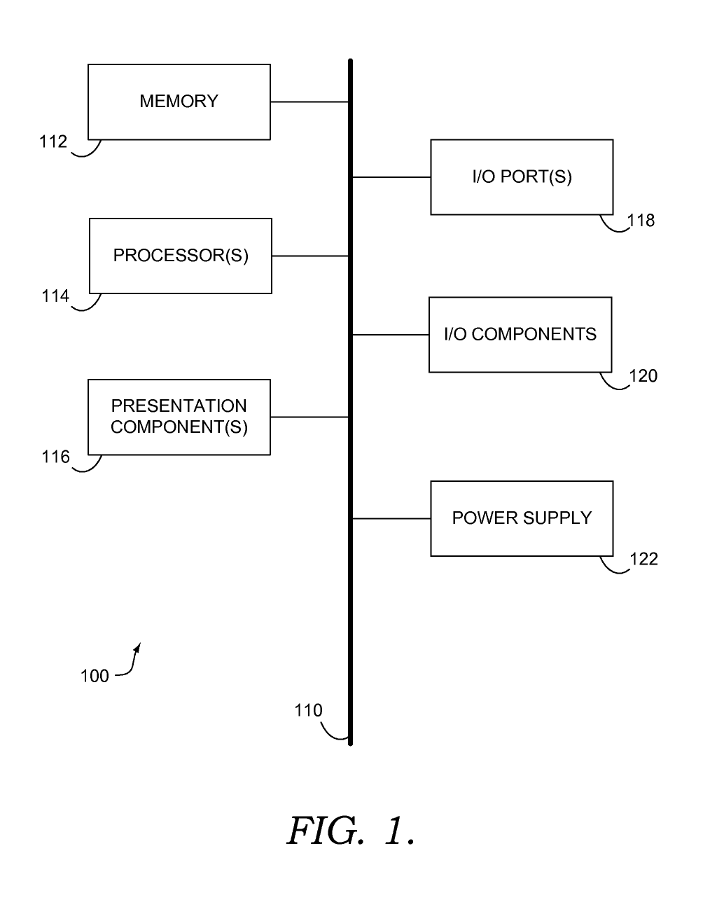

Having briefly described a general overview of the embodiments described herein, an exemplary operating environment is described below. Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, digital phone, handheld device, personal digital assistant (“PDA”), or other device capable of executing computer instructions.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

One way to decrease the effect of click fraud is to identify possible click-fraud perpetrators and software when they/it request a web page and allow advertisers to restrict their advertisements to web pages of a certain quality score. As described herein, a quality score refers to the probability that a selection of an advertisement impression is initiated from a user or by software attempting to induce click fraud. For example, a selection initiated from a known spyware program would have a drastically different quality score than a selection made by a first-time visitor to a web page. The quality score may also refer to the probability that a web page request or search-engine query is initiated from a user or by software attempting to induce click fraud.

While the discussion herein refers to a quality score as a probability, any indicative value may be used to designate a quality score. Embodiments are not limited to actual percentages or proportions. Rather, any value, such as a numeric, binary, hexadecimal, or the like may be used. For example, without limitation, a highly-suspicious user may be ranked as a 90% or tagged as .9, 0101 1010, 5A, or the like. Alternatively, the user may be assigned a quality score such as: “Gold,” “Silver,” or “Bronze.” Moreover, the quality score discussed herein may also include alphabetic words, phrases, or tags, such as “not suspicious,” “suspicious,” “highly suspicious,” or the like. One skilled in the art will appreciate that various methods for designating different degrees of a quality score can also be used.

Moreover, a quality score may is discussed herein with relation to the probability that a web-page request in fraudulent; however, other measures of web quality may be also used to measure quality scores. For example, the quality score may include a measure or indication of whether the web page was requested from a business or corporate computer. The quality score may alternatively reflect whether an online user has a propensity for shopping. This example could be performed by comparing the user's recent purchase transactions in a stored profile. Other methods of scoring the quality of a web-page request may also be used.

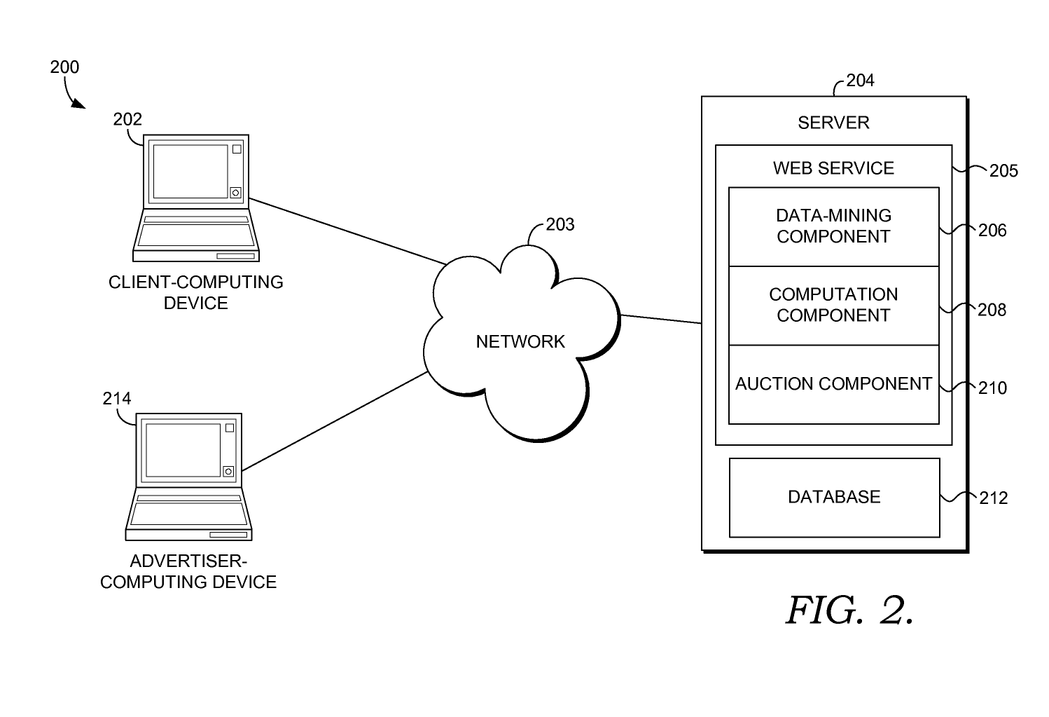

Referring to FIG. 2, a block diagram is provided showing an exemplary system 200 for determining the probability that a user or program will commit click fraud and displaying an advertisement on a web page, according to an embodiment of the present invention. System 200 comprises a client-computing device 202, a server 204 executing a web service 205, and an advertiser-computing device 214, all of which are configured to communicate via network 203.

Both the client-computing device 202 and the advertiser-computing device 214 may be any type of computing device, such as computing device 100 described above with reference to FIG. 1. By way of example only and not limitation, the client-computing device 202 and the advertiser-computing device 214 may be personal computers, servers, desktop computers, laptop computers, handheld devices, cellular phones, digital phones, PDAs, or the like. It should be noted that the embodiments are not limited to implementation on such computing devices, but may be implemented on any of a variety of different types of computing devices.

Network 203 may include any computer network or combination thereof. Examples of computer networks configurable to operate as network 206 include, without limitation, a wireless network, landline, cable line, fiber-optic line, LAN, WAN, or the like. Network 203 is not limited, however, to connections coupling separate computer units. Rather, network 203 may also comprise subsystems that transfer data between servers or computing devices. For example, network 203 may also include a point-to-point connection, tan internal system, Ethernet, backplane bus, electrical bus, neural network, or other internal system.

In an embodiment where network 203 comprises a LAN networking environment, components are connected to the LAN through a network interface or adapter. In an embodiment where network 203 comprises a WAN networking environment, components use a modem, or other means for establishing communications over the WAN, to communicate. In embodiments where network 203 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

The server 204 may include any type of application server, database server, or file server configurable to perform the methods described herein. In addition, the server 204 may be a dedicated or shared server. One example, without limitation, of a server that is configurable to operate as the server 204 is a structured query language (“SQL”) server executing server software such as SQL Server 2005, which was developed by the Microsoft® Corporation headquartered in Redmond, Wash.

Components of the server 204 (not shown for clarity) may include, without limitation, a processing unit, internal system memory, and a suitable system bus for coupling various system components, including the database 212 for storing information, such as advertisements. The server 204 will typically include, or have access to, a variety of the aforementioned computer-readable media. Specifically, the database 212 can be any of the previously-mentioned computer-readable media. By way of example only, and not limitation, computer-readable media may include computer-storage media and communication media. In general, communication media enables the server 204 to exchange data via network 203. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that system 200 is merely exemplary. While the server 204 is illustrated as a single box, one skilled in the art will appreciate that the server 204 is scalable. For example, the server 204 may, in actuality, include a plurality of servers in communication. Furthermore, the database 212, while illustrated within the server 204, may alternatively be located externally from the server 204. In such a configuration, the server 204 communicates with the database 212 via network 203. The single unit depictions in FIG. 2 are illustrated for clarity, not to limit the scope of embodiments.

In operation, the client-computing device 202 submits a request for a web page. In one embodiment, the request is submitted by a user entering a uniform resource locator (URL) with I/O components 120 into a text entry field of a web browser. The web browser then provides a mechanism for locating the web page affiliated with the URL by describing the page's Internet location. In an alternative embodiment, a user may select a hyperlink to access a web page. In still another embodiment, the user may submit a query to a search engine—for example, requesting a web search for “shoes.” In some embodiments, the request for a web page is transmitted to the server 204 via network 203. In alternative embodiments, attributes associated with the web-page request or search-engine query are transmitted to the server 204 via network 203.

In one embodiment, the requested web page is rendered by a web server (not shown for clarity). The web server may be any computing device that is configured to accept HTTP requests from a web browser executing on the client computing device 202. The web server is further configured to transmit HTML documents and linked objects (e.g., images, applets, etc.) associated with requested web pages or search engine queries. Moreover, the web server communicates with the server 204 to retrieve advertisements to display on a requested web page.

Embodiments will be discussed herein with reference to a web page request for the sake of clarity. But embodiments also contemplate the aforementioned methods of web navigation, specifically including a search-engine query. Therefore, any discussion herein related to a request for a web page may also be construed to include a query on a search engine (e.g., searching for “shoes”).

The server 204 comprises a web service 205 that is called when the page request or engine query is being rendered by the web server. The web service 205 may be any software system or application accessible over an open protocol. Examples of open protocols include, without limitation, simple object access protocol (SOAP), web services description language (WSDL), universal description discovery and integration (UDDI), web services security (WS-Security), web services reliable exchange (WS-ReliableExchange), etc. In one embodiment, the web service 205 is configured to determine which web advertisements to place on a requested web page.

In an embodiment, the web service 205 comprises a data-mining component 206, a computation component 208, and an auction component 210. Each component is a program, routine, application, or other machine-executable code capable of performing the actions discussed herein.

In an embodiment, the data-mining component 206 is configured to retrieve attributes from the page request. Attributes may include as any characteristic of the page request. Examples of attributes include, without limitation, an internet protocol (IP) address of the client-computing device 202, date, time, geographic location, metadata, key words, HTML tags, or other characteristics associated with the page request. Additionally, attributes may include characteristics associated with the user submitting the page request. For example, without limitation, the user's gender, ethnicity, age, web history, residence, etc. may also be retrieved from the page request. In an embodiment, retrieved attributes are stored in the database 212.

The data-mining component 206 is configured to retrieve the aforementioned attributes using various data-mining techniques well known to those skilled in the art. In one embodiment, cookies are sent from the web server to the web browser of the client-computing device 202, stored on the client-computing device 202, and sent back to the web server. In an embodiment, cookies provide the web server with the IP address of a user submitting a page request as well as the time the page was requested. Additionally, cookies can be configured to return the identity of a user requesting a web page, the number of new users who have accessed the web page, or how often a visitor has visited the web page. Such information can be an important tool in determining whether the user requesting the web page has a propensity for click fraud. For example, if the user has clicked on an advertisement—thus requesting the advertisement web page—thousands of times in a short amount of time, the user may have a high probability for click fraud. On the other hand, if a user is a first-time visitor to the web page, the user may be considered relatively safe. Cookies may also be configured to return profile information about a user to the web server. Profile information may include the user's geographic location, items in an e-commerce shopping cart, name, gender, age, ethnicity, or the like. Embodiments are not limited to any particular type of cookie; rather, various cookies can be implemented by embodiments discussed herein.

It will be understood by those of skill in the art that other methods besides cookies may also be used to retrieve attributes. For example, the page request itself will contain the IP address of the client-computing device 202. From the IP address, the geographic location of the client-computing device 202 can be determined. Also, a user's profile information may be sent along with the request or retrieved by the web server. Such data-mining techniques are generally well known to those skilled in the art and need not be discussed at length herein.

The computation component 208 is configured to calculate the quality score for the web-page request. In one embodiment, the computation component 208 receives the attributes as well as other parameters associated with the user or program initiating the request and executes a statistical model to calculate the quality score. Other parameters may include, without limitation, various web analytics, including the number of times the user or program has selected the advertisement, requested the web page, selected competitor advertisements, etc. Examples of statistical models may include, without limitation, a Bayesian model, regression model, neural network, decision tree, or other statistical model capable of determining the quality score for retrieved attributes.

In one embodiment, a rules-based model is used to calculate the quality score for a web-page request. In such an embodiment, rules are induced automatically using decision tree methods. These rules may be written in a language that will allow for if-then logic to be executed. Consequently, nearly any rule (or branch) may be implemented by designating the appropriate conditional statements. Examples of such languages that may be used to code the statistical models discussed herein include, without limitation, C, C++, C#, Java, or the like.

The following is an example model that may be implemented in various embodiments. The following explanation of variables is provided merely for exemplary purposes and should not be construed to limit embodiments described herein. User_clicks_since_midnight refers to a local variable which has been instantiated based on a web-page-request record and a table of User click counts that is updated every time a new record is loaded.

### Rule 1;

if User_clicks_since_midnight>X then Pr=0.95 end

The following rules, or well known adaptations thereof, may be implemented to identify robots, or automated systems, used to conduct click or impression fraud.

| | |
|---|---|
| Rule 1; | |
| | if (Left(userAgent, 3) = “IE1” and Length(userAgent)<10) then |
| | Pr = 0.5 end |
| Rule 2; | |
| | if IP_first_octet = 101 then Pr = Gold end |
| Rule 3; | |
| | if IP_first_octet = 102 and IP_second_octet = 100 then |
| | Pr = Silver end |
| Rule 4; | |
| | if IP_first_octet = 102 then |
| | Rule 41; |
| | Pr = 0.1 |
| | else |
| | Rule 42; |
| | If IP_second_octet = 104 then |
| | Rule 421 |
| | Pr = 0.01 |
| | end |

In an embodiment, if none of the above rules execute, the following rule executes.

### Rule 5

Pr =0.019
end

Rules (or “branches” of a decision tree) that are executed or called may be independently identified with various tags, hereinafter referred to as RuleIDs. Each branch of a decision tree may be given a unique name or number so that it is possible to track the impact of such a rule or branch. For a given decision tree, each RuleID could be analyzed by summing the impact of the branches beneath it.

In one embodiment, rules are executed according to the following pseudo-code:

```
Function P = AssignProbabilities(<v>)
    p = <> / * P starts off as an empty sequence */
    For each enriched request vector record, v e {v}
        Let <r> be the sequence of top-level rules in order as read from
        the model file
        pe = EvaluateRules(<r>, V)
        P = P ++ p
    End
Function p = EvaluateRules(<r>, v)
    For each top-level rule r e <r> in sequential order,
        If the conditional of r is true, then
              Let c be the consequent clause of r
              If c is a terminal probability then
                      return probability
              else
                      p = EvaluateRules(<c>, v)
              End
        End
    End
```

In an embodiment, the statistical model is called and executed in a web service independent of the web service 205. Calculated quality scores are stored, in some embodiments, in the database 212.

Once the quality score has been calculated, the auction component 210 selects advertisements to display on the requested web page. In one embodiment, the auction component 210 is configured to receive target criteria that a page request must meet before an advertisement can be displayed. An advertiser may select or enter the target criteria via a graphical user interface (GUI) on the advertiser-computing device 214 (as will be discussed in further detail below). In an embodiment, target criteria are stored in the database 212. Furthermore, target criteria may include any of the aforementioned attributes, a particular quality score, a list of one or more IP addresses, or any other characteristic. For example, an advertiser for a woman's shoe store in Paris may only wish to advertise to women in Paris requesting web pages with a low probability of click fraud. In one embodiment, the advertiser can specify a threshold quality score that a page request must have before an advertisement can be displayed. A threshold quality score can be any indicative value, key word, or phrase designating a particular quality score. In the same embodiment, the advertiser can also specify that the shoe store's advertisements only be displayed to women in Paris. Thus, the advertiser can effectively control the placement of advertisements by transmitting target criteria to the computation component 208.

It may also be advantageous to allow advertisers to specify the price they are willing to pay for a web page request from a user with a particular quality score. For example, an advertiser may be willing to pay $1.00 for a web page request from a user with a Gold quality score; whereas, the user may only be willing to pay $0.50 for a Silver quality score. In another example, the advertiser may only wish to pay $1.00 for a quality score of 0.6 or above on a Saturday between 1:00 pm and 3:00 pm in Seattle, Wash. In an embodiment, the advertiser enters the specified bid price along with a quality-score level, or other parameter, into a user interface on the advertiser-computing device 214 where such information is submitted to the auction component 210. The auction component 210 may be configured to receive such target criteria and select one of a plurality of advertisers from the submitted information.

The threshold quality score can be used in a negative matching technique to locate advertisements for display with a requested web page. In essence, negative matching techniques compare a quality score with the threshold quality scores of numerous advertisements. All advertisements with a threshold quality score exceeding the quality score are eliminated from contention for display. The advertisements that remain may be displayed. If numerous advertisements remain, auction component 210 may be configured to present the highest paying advertisements. Other methods of differentiating between multiple remaining advertisements may also be used, and are generally well known to those of skill in the art.

To locate advertisements, the auction component 210 may simply search for advertisement with target criteria that do not exceed the attributes and user or program parameters. In an embodiment, the auction component 210 compares the calculated probability of the requesting user or program, retrieved attributes of the request, and/or other parameters of the user or program with the target criteria to determine whether an advertisement should be displayed with the requested web page. In the same embodiment, if the attributes and parameters meet the advertiser's target criteria, the advertisement is selected for display.

The auction component 210 may also be configured to control advertisement pricing. In particular, the charge-per-click rate may be varied based on the probability for click fraud associated with a request. For example, in one embodiment, a discounted charge-per-click rate is charged to display an advertisement on a web page requested from a user or program with a high probability of click fraud. In the alternative, the auction component 210 may be configured to charge higher charge-per-click rates for lower probabilities of click fraud. Embodiments are not limited, however, to the aforementioned pricing schemes. Rather, any type of charge-per-click price structure may be used.

As previously mentioned, advertisers may specify a price per impression or charge-per-click rate. For example, Advertiser A may specify $1.00 to advertiser on a web page to users of a particular quality score, while Advertiser B only specifies $0.80. This enables advertisers to better control their advertising dollars while tempering a web site's interest to maximize profits. Moreover, various embodiments will allow the advertiser to designate a given impression or charge-per-click rate in conjunction with virtually any other web analytic parameter.

Once the auction component 210 locates advertisements to display on the requested web page, HTML and content information for the requested web page and the located advertisements are sent to the client-computing device 202. The web page and located advertisements are then displayed to the user. Therefore, an advertiser can be assured that advertisements are only displayed to users having a specific combination of quality score and attributes that meet the advertiser's target criteria.

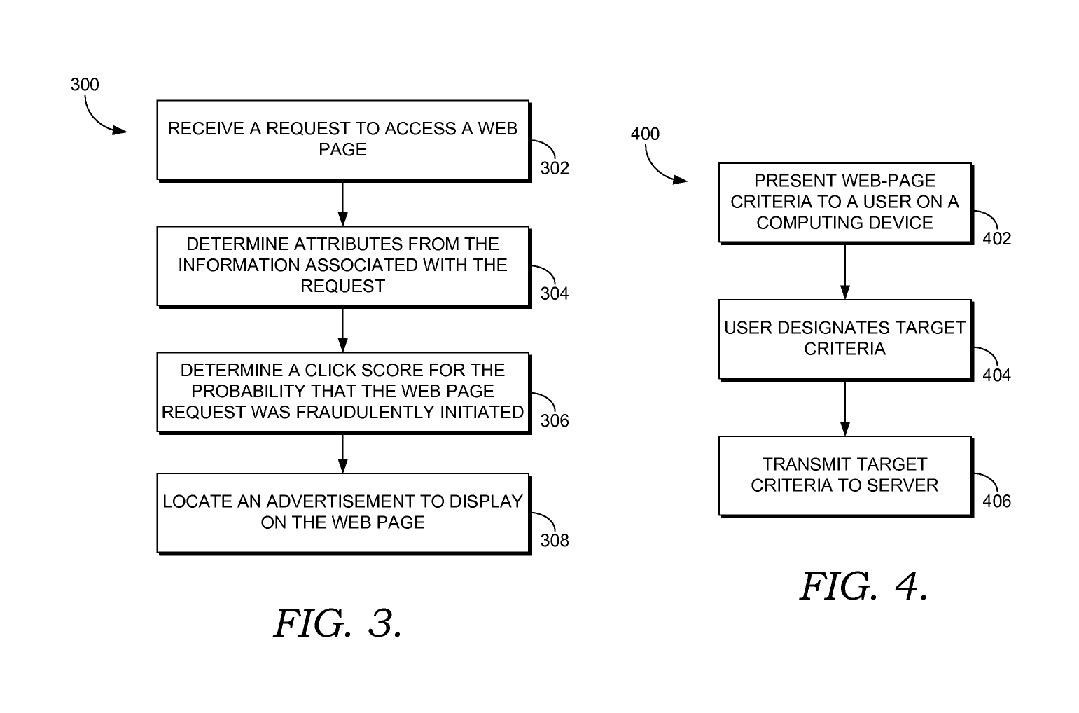

Turning now to FIG. 3, a flowchart is presented illustrating a process 300 for determining the probability that a user or program will commit click fraud and displaying an advertisement on a web page, according to an embodiment of the present invention. Initially, a request to access a web page is received by a web server, as indicated at block 302. As previously mentioned, a web page may be accessed through various means, such as entering a URL, clicking a hyperlink, submitting a query to a search engine, etc. In one embodiment, information associated with the request is sent to the server 204. Attributes relating to the user or program responsible for the request are determined from the information, as indicated at block 304. As previously mentioned, the attributes may include, without limitation, date, time, geographic location, gender, ethnicity, metadata, an IP address, etc. In an embodiment, cookies may be used to extract attributes. Other well-known mining techniques may also be used.

The attributes are used to determine the probability (i.e., quality score) that the request was fraudulently initiated, as indicated at block 306. Additionally, other user or program parameters may also be used in conjunction with the attributes to determine the probability. In one embodiment, a statistical model is used to calculate the probability. Statistical models may include a neural network, regression model, Bayesian model, or any other model. Furthermore, an advertiser may specify target criteria that the user or program must meet before the advertiser's advertisement can be displayed. For instance, the advertiser may specify a threshold quality score, geographic location, age, gender, web history, time of day, charge-per-click rate, impression price, and/or other characteristics.

The target criteria may be compared with the calculated probability and other parameters associated with the requesting user or program to locate an advertisement to display on the requested web page, as indicated at block 308. In one embodiment, a price structure determines the charge-per-click rate depending on the quality score of the page request. The price structure may offer a discounted charge-per-click rate depending on the probability of click fraud indicated by the quality score. Such a structure may commonly be referred herein as “incremental pricing.” This can be advantageous for many reasons. If an advertiser is worried about click fraud, the advertiser may wish to pay more for less risky traffic, and vice versa.

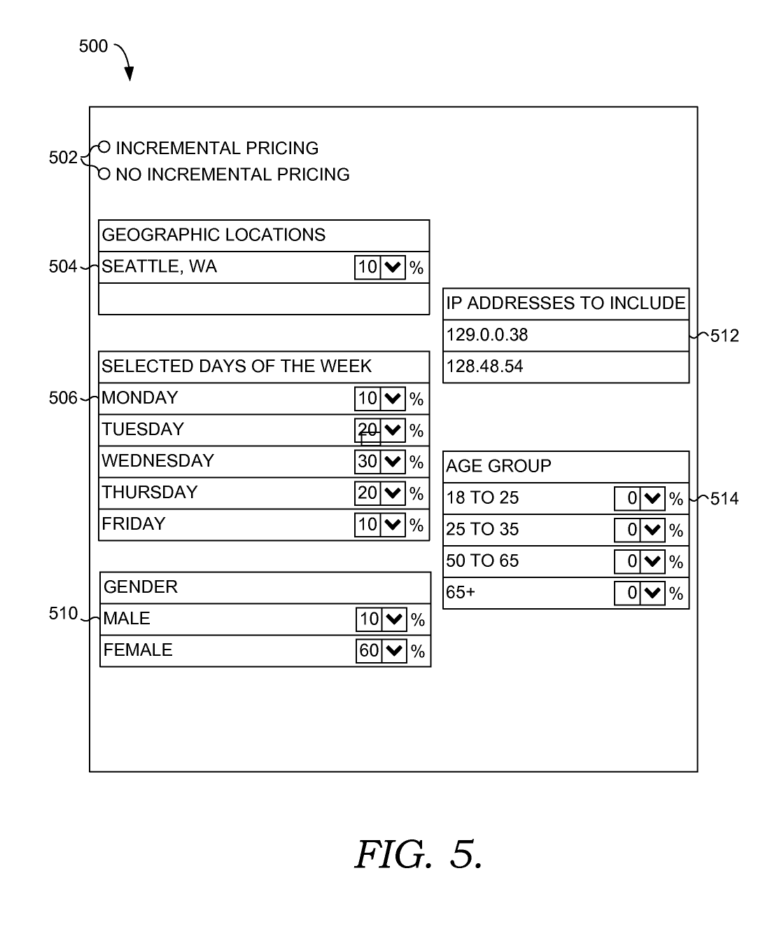

A flowchart is presented in FIG. 4 that illustrates a process 400 for an advertiser to specify target criteria, according to an embodiment of the present invention. Initially, web-page criteria are presented to a user (e.g., an advertiser) on a computing device, as indicated at block 402. In an embodiment, the web-page criteria is presented to the user on a graphical user interface, such as that shown in FIG. 5 (discussed below), on the advertising-computing device 214. The web-page criteria may include any of the previously mentioned attributes or parameters related to a user or program. Examples of possible web-page criteria include, without limitation, a geographic location, day of the week, age, gender, or list of IP addresses.

In an embodiment, the user specifies target criteria from the web-page criteria, as indicated at block 404. In one embodiment, target criteria comprise a threshold probability that a web page will be fraudulently requested. Alternatively, the user may enter target criteria not originally presented to the user as web-page criteria. Target criteria is transmitted to a server, as indicated at 406.

FIG. 5 illustrates a graphical user interface 500 (GUI 500) for an advertiser to specify target criteria, according to an embodiment of the present invention. It should be noted that GUI 500 is merely an exemplary GUI and embodiments should not be limited thereto. Furthermore, a myriad of target criteria may be specified by the advertiser using a plethora of techniques understood by those of skill in the art. FIGS. 5-8 illustrate numerous target criteria and several interfaces that may be combined either together or with other well know layouts, styles, or target criteria. In other words, FIGS. 5-8 are meant purely for illustrative purposes and should not be construed to limit embodiments discussed herein.

It may be desirous to allow a user to choose between multiple advertisement pricing structures. Option 502 presents as user with a display area configurable to select between multiple pricing structures. In one embodiment, the advertiser may choose between incremental pricing and non incremental pricing. As previously mentioned, incremental pricing varies the charge-per-click rate depending on the quality score of a request for a web page. For example, if user A and B request the same page but have quality scores of 90% and 10%, respectively, incremental pricing may charge a more expensive rate to click on an advertisements displayed before B than A. Alternatively, non incremental pricing may charge the same charge-per-click for both A and B. However, thresholds may be established for determining whether to include an advertisement for a particular request based on an associated quality score. As previously mentioned, numerous other pricing structures may also be contemplated by embodiments.

In an embodiment, one or more display areas are configured for different web-page criteria 504. While FIG. 5 illustrates “GEOGRAPHIC LOCATIONS,” “SELECTED DAYS OF THE WEEK,” “QUALITY SCORE,” “GENDER,” “IP ADDRESSES TO INCLUDE,” AND “AGE GROUP,” as target criteria that are respectively referenced with numerals 504, 506, 508, 510, 512, and 514, embodiments are not limited thereto. Rather, any characteristic of web-page traffic, including the attributes and parameters previously mentioned, may be web-page criteria 504.

Target criteria are created when the advertiser indicates web-page criteria in the GUI 500. For instance, days of the week to advertise may be selected area 506. In an embodiment, quality score percentages may be specified along therewith. As illustrated in FIG. 5, the advertiser has specified a quality score of 10% for Monday and a quality score of 20% for Tuesday as target criteria. In one embodiment, target criteria are designated according to quality score. For example, the advertiser in FIG. 5 has indicated a willingness to advertise to females with a quality score of 60% compared to males with a quality score of 10%. Other methods for selecting target criteria may also be used, and are generally well known to those skilled in the art.

An advertiser may also wish to block a particular IP address. This may occur if the advertiser is informed the IP address is notorious for click fraud. In an embodiment, IP addresses can be added as a target criteria to list 512. Once submitted to the server 214, the advertisers advertisement can subsequently be blocked from page requests originating from the addresses in the list 512.

Age groups 514 are another target criteria advertisers may wish to use for regulating advertisements. In an embodiment, the advertiser specifies a particular quality score for a given age group. Other methods of indicating age groups are also possible and will generally be well known to one skilled in the art.

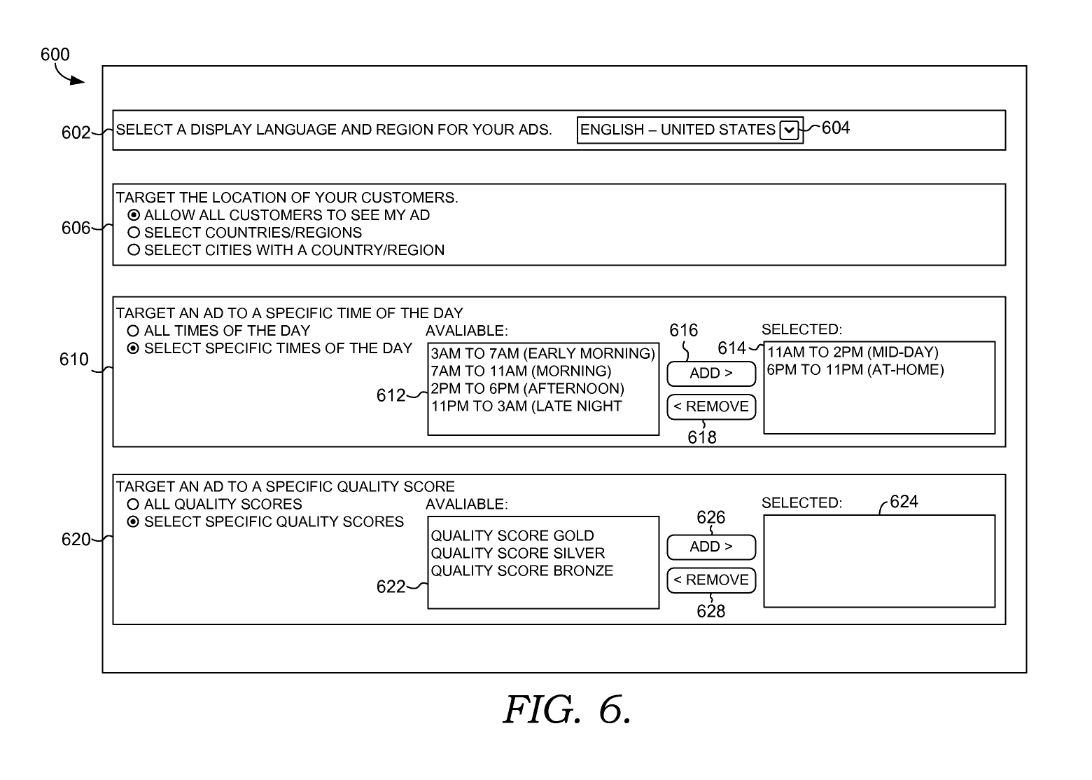

FIG. 6 illustrates a graphical user interface 600 (GUI 600) for an advertiser to specify target criteria, according to an embodiment of the present invention. In an embodiment, a display language may be displayed (602). Drop-down menu 604 can be used to display and select various languages. Additionally, the advertiser may wish to advertise to all users or restrict to geographic locations—as indicated by selection 606. If the advertiser selected to advertise to “SELECT CITIES WITH A COUNTRY/REGION,” a geographic location menu (such as area 504 in FIG. 5) may subsequently be illustrated and utilized to designate a geographic area. As depicted in area 504, a city such as Seattle, Wash. may be indicated along with (in an embodiment) a quality score.

An advertiser may also wish to enter a particular time of the day to advertise. For example, the maker of an insomnia drug may wish to advertise at night, rather than during the day. One method of specifying the time would be to list time increments in an AVAILABLE display area 612 and allow the advertiser to highlight the desired time increment and move it to a SELECTED display area 614 by selecting an ADD button 616. Conversely, selected time increments may be removed from the SELECTED display area 614 with the REMOVE button 618.

Advertisers may designate may target advertisements based on quality score. In one embodiment, the user specifies in display area 620 either to advertise to all quality scores or whether to select specific quality scores. For example, quality scores may be differentiated into multiple categories (e.g., GOLD, SILVER, and BRONZE), each of which corresponds to a range of quality scores. In the same example, GOLD could include quality scores from 0.7-1.0, SILVER could include quality scores from 0.3-0.69, and BRONZE could include quality scores from 0.0-0.29. If the advertiser selected Silver, his/her advertisements would not be displayed on web pages requested from users meeting the GOLD or BRONZE quality levels. To specify in different quality scores in GUI 600, the advertiser can highlight a given level and use the ADD 626 or REMOVE 628 buttons, which either add or remove the quality score to/from a SELECTED list area 624. Embodiments are not limited to the three quality scores in FIG. 6. Instead, one skilled in the art will understand that numerous other methods can also be used to designate a particular quality score.

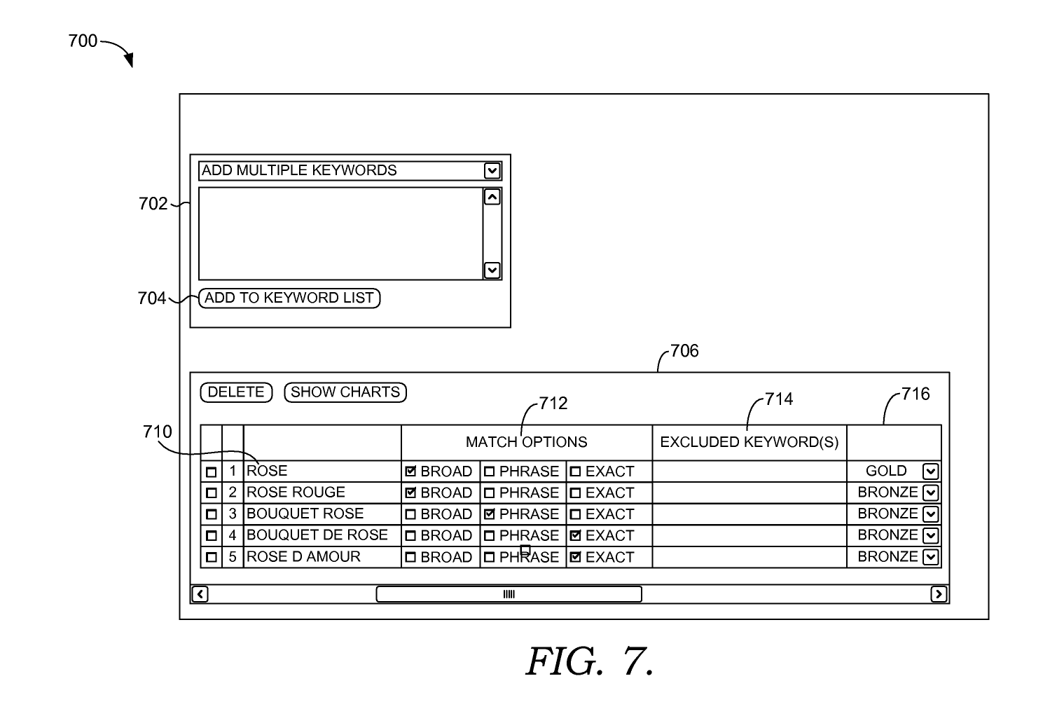

FIG. 7 illustrates a graphical user interface 700 (GUI 700) for an advertiser to specify target criteria, according to an embodiment of the present invention. An advertiser may wish to only advertise to people searching for a particular keyword or phrase. For example, advertising on a search engine may be less effective than advertising to users requesting a particular subject. If a drug manufacturer is looking to advertise an insomniac drug, it may not be fruitless to present advertisements for the drug to people searching for web pages about cats. Therefore, various embodiments let the advertiser specify keywords or phrases as target criteria.

Generally, GUI 700 allows the user to enter keywords into a keyword display area 702 and add them to a keyword list in display area 706 by selecting an ADD TO KEYWORD LIST button 704. Once the keywords are added, the advertiser may specify, through match options 712, whether to match the entire word or phrase either exactly or broadly. For example, it has been specified in FIG. 7 to only broadly match keyword ROSE and ROSE ROUGE, yet exactly match BOUQUET DE ROSE. Broad and exact matching techniques are generally well known to one of skill in the art and need not be discussed at length herein. Keywords or phrases may also be excluded from a particular keyword criteria by entering them into the EXCLUDED KEYWORD(S) display area 714. Moreover, the advertiser may also wish to specify a quality score necessary for each keyword or phrase by entering such into display area 716.

As previously discussed, some embodiments allow the advertiser to specify a bidding price for an impression of an advertisement. In other words, the advertise may designate a price for an impression, possibly in conjunction with any other target criteria, dictating the rate that the publisher or web site owner will receive per impression. For example, the advertiser may only be willing to pay $0.05 for an advertisement displayed as a result of a web-page request from a user with a GOLD quality score. In another example, the advertiser may only wish to pay $0.02 to display the advertisement web-page from a user with a 0.90 quality score.

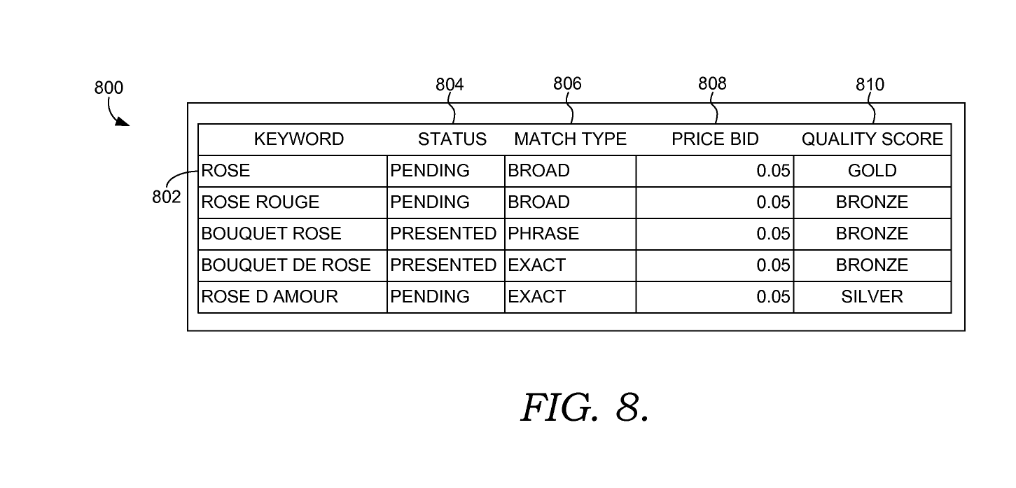

This concept is illustrated in FIG. 8, which depicts a graphical user interface 800 (GUI 800) of a keyword list specified by an advertiser, according to an embodiment of the present invention. In one embodiment, table 802 depicts keywords or phrases in a keyword list (e.g., the keyword list discussed with reference to FIG. 7). A status column 804, in an embodiment, illustrates the status of a particular advertisement with respect to a keyword in the list—such as whether the advertisement has been presented or is pending. In an embodiment, a MATCH TYPE column 806 indicates the type of matching criteria specified for the keyword or phrase.

A PRICE BID column 808 indicates, in an embodiment, the amount the advertiser is proposing to spend to present an advertisement on a web page requested by a user with all of the specified target criteria. Once specified, the advertisement can only be placed on a web page request with the other target criteria for the bid price. The bid price may further be used by an advertising service or web service (such as the web service 205) to identify which advertisements to place on the web page when multiple advertisers are requesting the same target criteria. For example, if the web service has fifty advertisers requesting an exact match of the phrase “rose d amour” at SILVER quality score, the web service may be configured to select the advertiser bidding the highest price. Other methods and techniques may also be employed to designate bid prices use such prices to identify which advertisements should be displayed.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer-readable media having computer-executable instructions for performing a method to present one or more advertisements on a web page, the method comprising:
receiving information associated with a web page request;
determining one or more attributes from the information;
based on the one or more attributes, determining a quality score indicative of whether the web page request was fraudulently initiated; and
based on the quality score, selecting the one or more advertisements to display on the web page.

2. The one or more computer-readable media of claim 1, wherein the one or more attributes include one of a date, time, geographic location, gender, ethnicity, or metadata.

3. The one or more computer-readable media of claim 1, wherein the web page request comprises a search-engine query.

4. The one or more computer-readable media of claim 1, wherein determining the one or more attributes from the information further comprises at least one of:
parsing the web page request for the one or more attributes; or receiving one or more cookies.

5. The one or more computer-readable media of claim 1, wherein a statistical model is used to determine the probability that the request was fraudulently initiated.

6. The one or more computer-readable media of claim 1, further comprising displaying the one or more advertisements on a client-computing device.

7. The one or more computer-readable media of claim 1, further comprising determining a charge-per-click rate to charge an advertiser based on the quality score.

8. The one or more computer-readable media of claim 1, further comprising:
receiving one or more target criteria from an advertiser; and
based on the one or target criteria, locating the one or more advertisements to display on the web page.

9. One or more computer-readable media having computer-executable components to present one or more advertisements on a web page, comprising:
a data-mining component configured to identify one or more attributes associated with a web-page request;
a computation component configured to calculate a probability that the web-page request was fraudulently initiated; and
an auction component configured to locate the one or more advertisements to display on the web page based on the probability.

10. The one or more computer-readable media of claim 9, further comprising a database to store the one or more advertisements.

11. The one or more computer-readable media of claim 9, wherein the computation component utilizes one of a Bayesian model, logistic-regression model, if-then model, or neural network to calculate the probability that the web-page request was initiated fraudulently from the computing device.

12. The one or more computer-readable media of claim 9, wherein the auction component is further configured to receive one or more target criteria from a user.

13. The one or more computer-readable media of claim 12, wherein the one or more target criteria includes a threshold probability that the web page was fraudulently requested.

14. The one or more computer-readable media of claim 12, wherein the auction component is further configured to locate the one or more advertisements based on the one or more target criteria.

15. The one or more computer-readable media of claim 12, wherein the auction component is configured to locate the one or more advertisements to display on the web page based on the probability by comparing the probability with one or more threshold probabilities associated with the one or more advertisements.

16. In a computer system having a graphical user interface including a display and a user interface selection device, a method of designating one or more target criteria to reduce click fraud by restricting the web pages that an online advertisement is displayed on, comprising:
presenting one or more web-page criteria on the display;
allowing a user to designate the one or more target criteria with the user-interface selection, wherein the one or more target criteria are associated with the characteristics of a web-page request and comprise at least an indication of a quality score; and
transmitting the one or more target criteria.

17. The computer system of claim 16, wherein the one or more target criteria includes a threshold probability that a web page request was fraudulently initiated.

18. The computer system of claim 16, wherein the display further comprises a display area for the user to elect between two or more advertisement pricing schemes based on a probability that a web-page request was fraudulently initiated.

19. The computer system of claim 16, wherein the one or more web-page criteria are presented on the display in a display area that includes one of a geographic location, day of the week, age, or gender.

20. The computer system of claim 16, wherein the one or more target criteria further comprise a threshold probability to be compared with a quality score associated with one of a web page request or a search engine query.
